(19) United States
(12) Patent Application Publication
(10) Pub. No.: US 2019/0039291 A1
(43) Pub. Date: Feb. 7, 2019

(54) THREE-DIMENSIONAL OBJECT AND METHOD FOR SHAPING THREE-DIMENSIONAL OBJECT

(71) Applicant: MIMAKI ENGINEERING CO., LTD., Nagano (JP)

(72) Inventor: Kunio Hakkaku, NAGANO (JP)

(73) Assignee: MIMAKI ENGINEERING CO., LTD., Nagano (JP)

(21) Appl. No.: 16/052,648

(22) Filed: Aug. 2, 2018

(30) Foreign Application Priority Data
Aug. 3, 2017 (JP) 2017-150838

(51) Int. Cl. B29C 64/165; B33Y 10/00; B33Y 80/00; B33Y 70/00

(52) U.S. Cl. CPC B29C 64/165; B33Y 10/00; B29K 2105/251; B33Y 70/00; B29K 2995/002; B33Y 80/00

(57) ABSTRACT

Provided is a three-dimensional object improved in coloration of a colored region formed therein. The three-dimensional object is shaped by a layer lamination technique and includes a colored region having a certain thickness in a surface normal direction. In the three-dimensional object, a white color ink and a transparent ink are used to compensate for insufficiency of an ink density in any portion of the colored region in which a color ink(s) alone fails to fulfill a predetermined ink density, and a higher proportion of the white color ink than the transparent ink is used on an inner side, while a higher proportion of the transparent ink than the white color ink is used on an outer layer side.

### CROSS REFERENCE TO RELATED APPLICATIONS

This application claims the priority benefit of Japanese Patent Application No. 2017-150838, filed on Aug. 3, 2017. The entirety of the above-mentioned patent application is hereby incorporated by reference herein and made a part of this specification.

### TECHNICAL FIELD

The present disclosure relates to a three-dimensional object having a colored region formed from an inner side toward an outer layer side, and a method for shaping the three-dimensional object.

### BACKGROUND ART

In some of the known three-dimensional objects in which a colored region is formed, the colored region may be formed by a layer lamination technique (for example, Japanese Unexamined Patent Publication No. 2015-147328). In such three-dimensional objects, a supplementary ink may be further used to compensate for insufficiency of an ink density in any portion of the colored region failing to fulfill a predetermined ink density.

Patent Literature 1: Japanese Unexamined Patent Publication No. 2015-147328

### SUMMARY

In the three-dimensional object described in Japanese Unexamined Patent Publication No. 2015-147328, a transparent ink is used as a supplementary ink for the colored region, and a light-reflective layer is formed with a white color ink on an inner side (center side) than the colored region. In this three-dimensional object, therefore, an incident light entering the three-dimensional object transmits through the colored region and is reflected by the light-reflective layer. Then, the reflected light transmits though the colored region again and exits the three-dimensional object. The three-dimensional object thus obtained may have a colored surface that depends on coloration of the colored region.

In the three-dimensional object described in Japanese Unexamined Patent Publication No. 2015-147328, the light-reflective layer alone reflects the incident light, which makes it difficult to improve coloration of the colored region. This may be particularly prominent with three-dimensional objects in the form of thin plates and three-dimensional objects with thick colored regions, because of difficulty in ensuring enough thickness of the light-reflective layer. As a result, the quality of colors to be produced may be degraded.

To address the issue of the known art, the present disclosure provides a three-dimensional object having a colored region improved in coloration, and a method for shaping the three-dimensional object.

A three-dimensional object disclosed herein is shaped by a layer lamination technique and includes a colored region having a certain thickness in a surface normal direction. In this three-dimensional object, a white color ink and a transparent ink are used to compensate for insufficiency of an ink density in a portion of the colored region in which a color ink alone fails to fulfill a predetermined ink density.

A method for shaping a three-dimensional object disclosed herein shapes a three-dimensional object by a layer lamination technique. The three-dimensional object includes a colored region having a certain thickness in a surface normal direction. This method uses a white color ink and a transparent ink to compensate for insufficiency of an ink density in a portion of the colored region in which a color ink alone fails to fulfill a predetermined ink density.

According to this configuration, the ink density in the colored region may be adjusted by combined use of the white color ink and the transparent ink. In this configuration, the white color ink may reflect incident light entering the colored region, while the transparent ink may transmit therethrough the incident light. When a light-reflective region is formed on the inner side than the colored region, light is reflected in the colored region and is reflected in the light-reflective region as well. As a result, vivid coloration may be feasible in the colored region.

A higher proportion of the white color ink than the transparent ink may be used on an inner side, and a higher proportion of the transparent ink than the white color ink may be used on an outer layer side.

The colored region may be formed, so that a higher proportion of the white color ink than the transparent ink is used on the inner side of the three-dimensional object, and a higher proportion of the transparent ink than the white color ink is used on the outer layer side of the three-dimensional object.

There are two effects with use of the white color ink: light reflecting effect, and light blocking effect. Therefore, when light is entering the colored region, the possibility of the light being blocked by the transparent ink may be reduced by increasing the proportion of the transparent ink used on the outer layer side of the three-dimensional object. When light is being transmitted through color components of the colored region, the possibility of the light being blocked by the white color ink may be reduced by increasing the proportion of the white color ink used on the inner side of the three-dimensional object.

The white color ink and the transparent ink may be used at a half-and-half ratio.

The white color ink and the transparent ink thus used at a half-and-half ratio may facilitate allocation of these inks when object-shaping data is generated to produce a three-dimensional object. This may alleviate any loads associated with computations necessary for generating the object-shaping data.

The three-dimensional object may further include a light-reflective region being disposed on the inner side than the colored region.

According to this configuration, light transmitted through the colored region may be reflected well in the light-reflective region. This may improve coloration of the colored region.

The three-dimensional object may further include a dividing region being disposed between the colored region and the light-reflective region.

According to this configuration, the dividing region may avoid any physical interference between the colored region and the light-reflective region. As a result, the transmission of incident light through the colored region and the reflection of incident light in the light-reflective region may be both successfully facilitated and improved.

The three-dimensional object may further include a protective region being disposed on the outer layer side than the colored region, and at least one of the protective region and the dividing region may be formed with the transparent ink.

According to this configuration, the colored region may be protected with the protective region. The transparent ink may be conveniently used to form the protective region and the dividing region. This may avoid any unnecessary increase of the number and types of inks to be used.

The three-dimensional object and the three-dimensional object shaping method according to the present disclosure may both serve to improve coloration of the colored region.

### BRIEF DESCRIPTION OF THE DRAWINGS

FIG. 1 is a perspective external view of a three-dimensional object according to an embodiment of the present disclosure.

FIG. 2 is a cross-sectional view of the three-dimensional object according to the embodiment.

FIG. 3 is a cross-sectional view in part of a slice layer in the three-dimensional object according to the embodiment.

FIG. 4 is a drawing that illustrates locations of components (voxels) constituting the three-dimensional object according to the embodiment.

FIG. 5 is a block diagram schematically illustrating an overall structure of an object shaping apparatus used in a three-dimensional object shaping method according to the embodiment.

FIG. 6 is a drawing of a carriage viewed in Z direction.

FIG. 7 is a drawing of a carriage viewed in X direction.

### DESCRIPTION OF EMBODIMENTS

Embodiments of the present disclosure are hereinafter described referring to the accompanying drawings. It should be understood that the scope of the present disclosure is not confined by the embodiments hereinafter described. Any structural elements described in the embodiments may include means replaceable by those skilled in the art and substantially identical means. The structural elements may be suitably combined, and more than one embodiment hereinafter described may be optionally combined.

### Embodiments

A three-dimensional object 1 according to an embodiment is shaped by inkjet printing using inkjet heads. While the description of this embodiment focuses on the object shaping method using the conventional inkjet printing technique, the present disclosure is not limited to such a method but is applicable to any other method for shaping three-dimensional objects using the layer lamination technique. For example, inkjet ejection of binding inks using, colored resin powder may be employed to form layers that constitute a colored region.

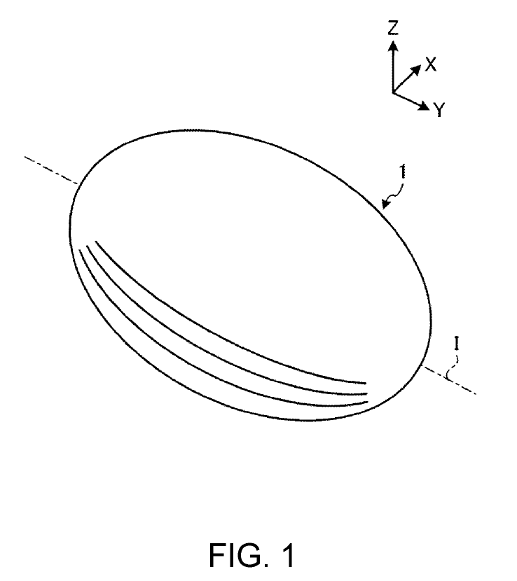

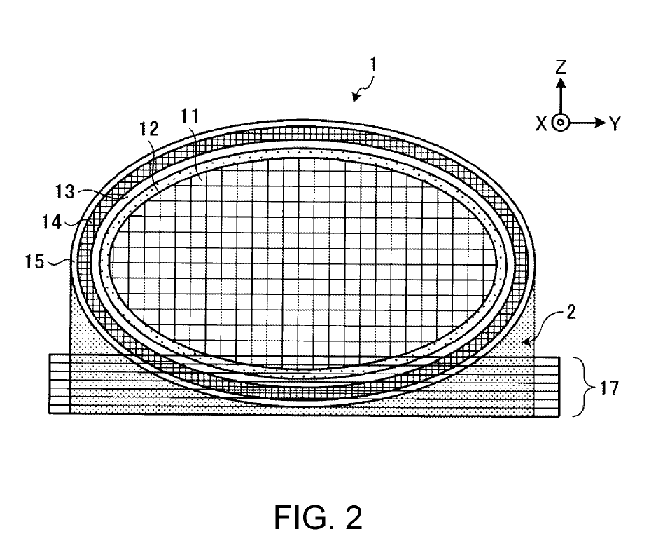

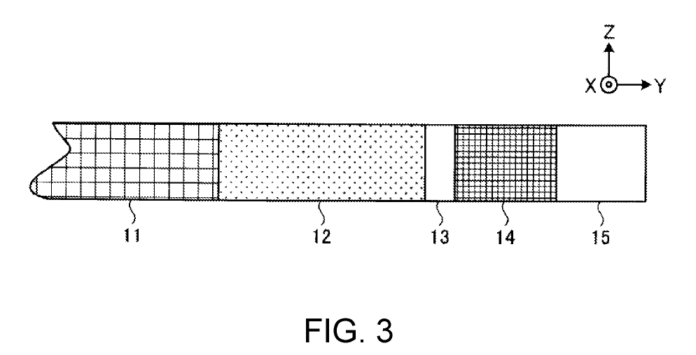

FIG. 1 is a perspective external view of the three-dimensional object according to this embodiment. FIG. 2 is a cross-sectional view of the three-dimensional object according to this embodiment. FIG. 3 is a cross-sectional view in part of the three-dimensional object according to this embodiment.

In the embodiment illustrated in FIG. 1, the three-dimensional object 1 may be an oval object having a central axis I extending along the direction of a major axis and minor axes extending in a direction orthogonal to the central axis I. This is specifically an object like a rugby ball that the oval shape is rotatable around the central axis I. FIG. 1 illustrates this object in an XYZ three-dimensional coordinate system, in which the major axis extends along the Y direction, the horizontal minor axis extends along the X direction, and the vertical minor axis extends along the Z direction. While this embodiment describes the three-dimensional object 1 shaped like a rugby ball, the shape of this object is not particularly limited and may be any other suitable shape.

FIG. 2 is a cross-sectional view of FIG. 1, showing a Y-Z plane along the central axis I. FIG. 3 is a partly enlarged view of a slice layer on a side surface of the three-dimensional object 1 illustrated in FIG. 2. As illustrated in FIG. 2 and FIG. 3, the three-dimensional object 1 has a plurality of regions formed from its inner side toward outer layer side (outer side). Specifically, the three-dimensional object 1 has, in the normal direction of its outer surface, an object-shaping region 11, a light-reflective region 12, a dividing region 13, a colored region 14, and a protective region 15, which are arranged in this order from the inner side. The three-dimensional object 1 further has a support 2 (not illustrated in FIG. 3) below an overhanging portion (portion protruding outward from the bottom surface to support the three-dimensional object 1). The formation of the overhanging portion is assisted by the support 2. As described later, the support 2 is separable from the three-dimensional object 1 finally completed.

The object-shaping region 11 constitutes the basic structure of the three-dimensional object 1 and is formed with a predetermined ink. The object-shaping region 11 may be formed with a white color ink. The interior of this region, though not particularly limited, may have a solid core or may be partly hollow as in a skeleton-like shape (frame-like shape). The ink used to form object-shaping region 11 is not limited to the white color ink, and may be a transparent ink, a color ink, or a mixture of the transparent and color inks.

The light-reflective region 12 is formed in the shape of a layer on the outer side than the object-shaping region 11 so as to cover the whole outer surface of the object-shaping region 11. The light-reflective region 12 reflects light transmitted through the colored region 14 as described later. The light-reflective region 12 is formed with, for example, the white color ink to serve the purpose of light reflection. The ink used to form the light-reflective region 12 is not limited to the white color ink, and may be any suitable one selected from light-reflecting inks. The light-reflective region 12 may have a uniform thickness at any position in the outer surface normal direction. The reflectivity of visible light by the light-reflective region 12 may be at least 60% or more, or may desirably be 80% or more.

The dividing region 13 is formed in the shape of a layer on the outer side than the light-reflective region 12 so as to cover the whole outer surface of the light-reflective region 12. The dividing region 13 is aimed at avoiding any physical interference between the light-reflective region 12 and the colored region 14 described later. The dividing region 13 is formed with a transparent ink not to block light from transmitting through between the colored region 14 and the light-reflective region 12. With no physical interference between these regions, the dividing region 13 may be unnecessary.

The colored region 14 is formed in the shape of a layer on the outer side than the dividing region 13 so as to cover the whole outer surface of the dividing region 13. The colored region 14 is the origin of a color(s) to be expressed on the surface of the three-dimensional object 1. The colored region 14 is formed with a color ink(s) and, if necessary, a supplementary ink in order to produce a color(s) previously set. The colored region 14 is formed in a smaller thickness in the normal direction than the light-reflective region 12, so that a desired resolution of the surface coloration is not undermined. The thickness of the colored region 14 may be less than or equal to 500 μm, and may desirably be less than or equal to 200 μm.

The protective region 15 is formed in the shape of a layer on the outer side than the colored region 14 so as to cover the whole outer surface of the colored region 14. The protective region 15 protects the colored region 14 to avoid discoloration due to exposure to ultraviolet light, and any physical damage such as scratches. The protective region 15 is formed with a transparent ink, so that coloration of the colored region 14 is not concealed. The protective region 15 may be unnecessary in a case where the colored region 14 has an adequate thickness or glossiness resulting from the transparent ink is undesired.

The three-dimensional object 1 described so far is shaped by the layer lamination technique using inkjet printing. To shape the three-dimensional object 1, a plurality of slice layers 17 extending along a horizontal plane (X-Y plane) are stacked on one another in the vertical direction (Z direction). The slice layers 17 are formed of inks ejected and cured by an object shaping apparatus described later based on slice data. While all of the inks used are curable by ultraviolet irradiation, a support ink used to form the support 2 alone is soluble in water even after being cured and is removable by immersing the object in water after an operation to shape the object is over.

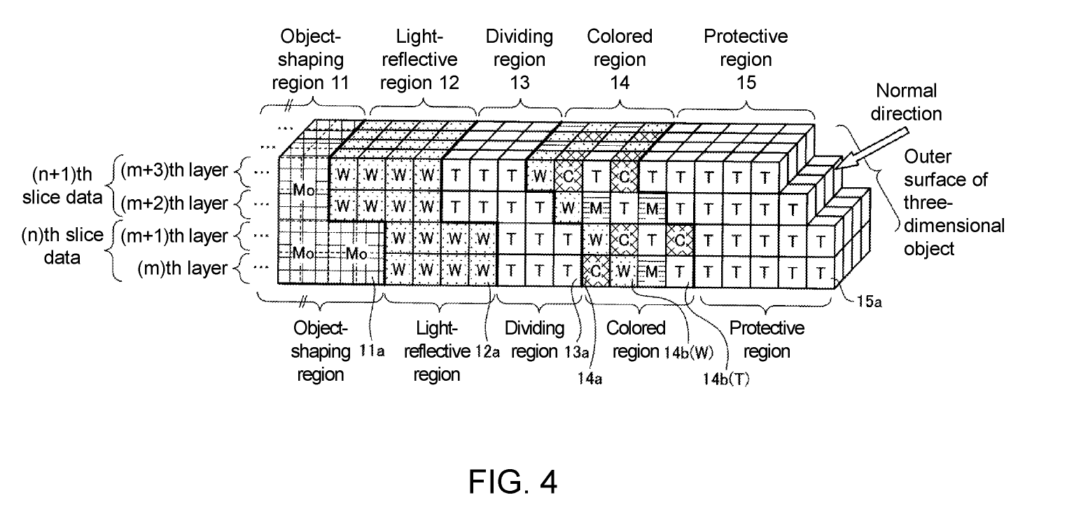

Next, pieces of slice data representing components that constitute different regions in the three-dimensional object 1 are described referring to FIG. 4. FIG. 4 is a drawing that illustrates locations of the components (ink droplets, voxels) constituting the three-dimensional object 1 according to the embodiment. As illustrated in FIG. 4, the object shaping apparatus described later forms the slice layers 17 based on pieces of slice data and stacks the formed slice layers 17 on one another in the vertical direction (Z direction) to shape the three-dimensional object 1. The support 2 is not illustrated in FIG. 4.

The pieces of slice data illustrated in FIG. 4 are each generated for two layers, which are (n)th slice data, and (n+l)th slice data on the vertically upper side of the (n)th slice data. The (n)th slice data includes a (m)th layer which is a base layer and a (m+1)th layer immediately above the (m)th layer. The (n+1)th slice data includes a (m+2)th layer immediately above the (m+1)th layer, and a (m+3)th layer immediately above the (m+2)th layer. Thus, the piece of slice data for one layer includes two layers each formed by one voxel. In the layers from the (m)th layer through (m+3)th layer, their thicknesses in the Z direction mostly have component values (ink droplets, voxels) that are appropriate for multicolored printing in the colored region 14 by subtractive color mixing. The values may be, for example, between 15 μm and 50 μm.

In the (n)th slice data, the object-shaping region 11 is formed based on an object-shaping component 11a for two layers; (m)th layer and (m+1)th layer. In the (n+1)th slice data, the object-shaping region 11 is formed based on an object-shaping component 11a for two layers; (m+2)th layer and (m+3)th layer. Specifically, the object-shaping component 11a is a 2×2×2 voxel, while the other components described later is each a 1×1×1 voxel. Thus, the object-shaping component 11a represents a greater voxel than the other components. In a process to shape the object-shaping region 11 based on the object-shaping components 11a, therefore, the process may be accelerated by increasing the amount of ink ejected for the object-shaping region 11, increasing the number of inkjet heads describe later (for example, twofold), and/or ejecting different inks respectively from different inkjet heads. As for the object-shaping components 11a as described earlier, a white color ink W may be used as an object-shaping ink Mo, which may allow the object-shaping region 11 and the light-reflective region 12 to be formed together. The object-shaping component 11a may be a 1×1×1 voxel like the other components.

The light-reflective region 12 is formed based on reflection components 12a in the (m)th layer through the (m+3)th layer. Specifically, the reflection component 12a is a 1×1×1 voxel and is formed with the white color ink W as described earlier. The light-reflective region 12 has a thickness of, for example, 500 μm, in the outer surface normal direction of the three-dimensional object 1.

The dividing region 13 is formed based on division components 13a in the (m)th layer through the (m+3)th layer. Specifically, the division component 13a is a 1×1×1 voxel and is formed with a transparent ink T as described earlier.

The colored region 14 is formed based on color components 14a and supplementary components 14b in the (m)th layer through the (m+3)th layer. Specifically, the color component 14a is a 1×1×1 voxel. In the colored region 14, color inks are allocated by the dither matrix or error diffusion method in accordance with color data included in the slice data. The supplementary component 14b is a 1×1×1 voxel. As described earlier, the supplementary ink is used at any voxel at which the color ink has failed to be applied.

The color components 14a include color inks having process colors for subtractive color mixing; yellow (Y), magenta (M), cyan (C), and black (K), and are appropriately allocated based on a desired color tone of the three-dimensional object 1. In FIG. 4, for example, the color components 14a are magenta (M) and cyan (C). While this embodiment uses the YMCK color inks, the color inks may be selected from inks having pale colors of YMCK, and red (R), green (G), blue (B), and metallic (silver) color inks.

The supplementary component 14b includes a white color supplementary component W using the white color ink (W) and a transparent supplementary component T using the transparent ink (T). The supplementary component 14b is allocated based on a desired color tone of the three-dimensional object 1. When the three-dimensional object 1 desirably has a bright color tone lower in color density, for example, the color inks alone may be insufficient for a predetermined ink density in the colored region 14. Therefore, a supplementary ink (i.e., white color ink or transparent ink) is used to compensate for insufficiency of the ink density in the colored region 14.

There are two effects with use of the white color supplementary component W: light reflecting effect and light blocking effect for incident light entering the colored region 14. Therefore, a greater number of white color supplementary components W than the transparent supplementary components T are formed on the inner side, so that light entering the colored region 14 is adequately reflected. The transparent supplementary component T transmits therethrough light entering the colored region 14. Therefore, a greater number of transparent supplementary components T than the white color components W are formed on the outer layer side, so that light entering the colored region 14 is adequately transmitted through.

In the supplementary component 14b, the white color supplementary components W (white color ink) and the transparent supplementary components T (transparent ink) are used at a half-and-half ratio. Then, when the thickness of the colored region 14 is divided into two halves at the center in the outer surface normal direction of the three-dimensional object 1, the white color supplementary components W are allocated to a region of the thickness of the colored region 14 on the inner side, and the transparent supplementary components T are allocated to a region of the thickness of the colored region 14 on the outer layer side. The supplementary ink for the supplementary component 14a may be at least supplied in such an amount that allows each layer to have an enough thickness. Any excess of the ink is removed by a flattening roller R described later.

The protective region 15 is formed based on protection components 15a in the (m)th layer through the (m+3)th layer. Specifically, the protection component 15a is a 1×1×1 voxel and is formed with the transparent ink T.

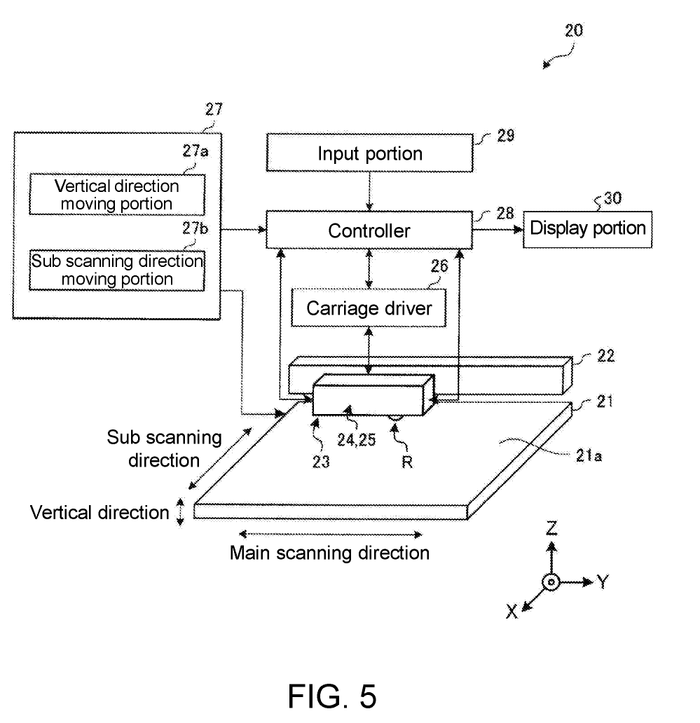

An object shaping apparatus 20 for shaping the three-dimensional object 1 is hereinafter described referring to FIG. 5. As illustrated in FIG. 5, the object shaping apparatus 20 has an object table 21, a Y bar 22, a carriage 23, inkjet heads 24, an ultraviolet irradiator 25, a flattening roller R, a carriage driver 26, an object table driver 27, a controller 28, an input portion 29, and a display portion 30.

The object table 21 is a plate-like member extending along a horizontal plane, and the vertical upper surface of this table is a working plane 21a. The working plane 21a is flat and parallel to the horizontal plane. The object-shaping material is ejected to and stacked in layers at positions on the working plane 21a to shape thereon the three-dimensional object 1 and the support 2. The working plane 21 of the object table 21 may have a substantially rectangular shape, which is, however, not limited.

The Y bar 22 is disposed on the vertically upper side of the object table 21 at a predetermined interval from the object table 21. The Y bar 22 is disposed straight along the main scanning direction (Y direction) parallel to the horizontal direction (Y axis). The Y bar 22 supports the carriage 23 that reciprocates along the main scanning direction.

The carriage 23 is held by the Y bar 22 and controlled to move along the Y bar 22 in the main scanning direction. The inkjet heads 24 are held by the carriage 23 on its surface vertically facing the working plane 21a of the object table 21.

The inkjet heads 24 eject the color inks as functional inks, supplementary ink, and object-shaping ink Mo to the working plane 21a. An example of the functional ink is an ultraviolet-curable ink. The inkjet heads 24 are mounted in the carriage 23 with the ultraviolet irradiator 25. The ultraviolet irradiator 25 irradiates the ultraviolet-curable inks that have landed on the working plane 21a with ultraviolet light.

The inkjet heads 24 are mounted in the carriage 23 and are thereby allowed to reciprocate in the main scanning direction as the carriage 23 moves in the main scanning direction. The inkjet heads 24 are coupled to ink tanks, not illustrated in the drawings, mounted in the carriage 23 through, for example, ink flow paths, regulators, and pumps. The object shaping apparatus 20 is provided with more than one inkjet heads 24 in accordance with different types of ultraviolet-curable inks used to shape the three-dimensional object 1. The ultraviolet-curable inks in the ink tanks are inkjet-ejected from the inkjet heads 24 to the working plane 21a of the object table 21.

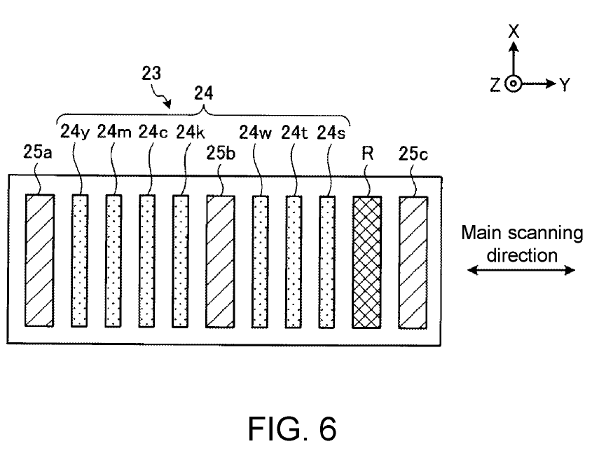

Specifically, the inkjet heads 24 include, in the order of arrangement from one side in the Y direction (left side on FIG. 6), an inkjet head 24y that ejects yellow (Y) color ink, an inkjet head 24m that ejects magenta (M) color ink, an inkjet head 24c that ejects cyan (C) color ink, and an inkjet head 24k that ejects black (K) color ink. The inkjet heads 24 further include, in the order of arrangement from one side in the Y direction (left side on FIG. 6), an inkjet head 24w that ejects the white color (W) ink, an inkjet head 24t that ejects the transparent ink (T), and an inkjet head 24s that ejects the support ink. These inkjet heads 24 are electrically coupled to the controller 28 and are prompted to operate by the controller 28. In this embodiment, the object-shaping ink (Mo) includes the white color (W) ink.

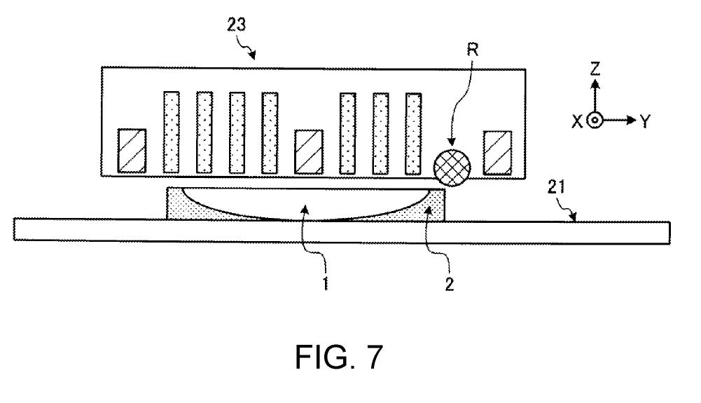

The flattening roller R is mounted in the carriage 23 and flattens the slice layers 17 consisting of voxels so as to have a uniform thickness (thickness in Z direction). The flattening roller R may be disposed between the inkjet head 24s and a third UVLED 25c described later. In FIG. 5 and FIG. 7, the flattening roller R rotates clockwise as the carriage 23 moves for scans leftward in the Y direction (left side in FIG. 5 and FIG. 7) and thereby removes any excess of the ink on the upper surface of a respective one of the slice layers 17 so as to flatten the slice layer 17.

The ultraviolet irradiator 25 is mounted in the carriage 23 with the inkjet heads 24 as described earlier, and may have an LED module configured to radiate ultraviolet light. The ultraviolet irradiator 25 includes a first UVLED 25a, a second UVLED 25b, and a third UVLED 25c. The first UVLED 25a and the third UVLED 25c are disposed on both end sides of the group of inkjet heads 24 in the Y direction. The second UVLED 25b is disposed between the white color inkjet head 24w and the group of color inkjet heads 24y, 24m, 24c, and 24k. All of the three UVLEDs are used to obtain the three-dimensional object 1 having a colored surface. To obtain the three-dimensional object 1 having a white-colored or transparent surface without having to use any color ink, the second UVLED 25b and the third UVLED 25c alone may be used, in which case a high-speed operation is possible because of a shorter scanning distance in the Y direction.

The ultraviolet irradiator 25 mounted in the carriage 23 with the inkjet heads 24 is allowed to reciprocate in the main scanning direction as the carriage 23 moves in the main scanning direction. The ultraviolet irradiator 25 is electrically coupled to the controller 28 and is prompted to operate by the controller 28.

The carriage driver 26 drives the carriage 23, i.e., inkjet heads 24, flattening roller R, and ultraviolet irradiator 25 mounted in the carriage 23, to reciprocate (for scans) along the Y bar 22 in the main scanning direction. The carriage driver 26 may include a power transmission mechanism coupled to the carriage 23 such as a transport belt, and a driving source that drives the transport belt such as a motor. The carriage driver 26 converts, through the power transmission mechanism, motive power generated by the driving source into power that reciprocates the carriage 23 in the main scanning direction and thereby reciprocates the carriage 23 in the main scanning direction. The carriage driver 26 is electrically coupled to the controller 28 and is prompted to operate by the controller 28.

As illustrated in FIG. 5, the object table driver 27 includes a vertical direction moving portion 27a and a sub scanning direction moving portion 27b. The vertical direction moving portion 27a moves the object table 21 upward and downward in the vertical direction parallel to the Z axis so as to move the working plane 21a of the object table 21 vertically upward and downward relative to the flattening roller R. The flattening roller R accordingly flattens each of the slice layers 17 in a uniform thickness in the Z direction.

The sub scanning direction moving portion 27b moves the object table 21 in the sub scanning direction parallel to the X axis orthogonal to the main scanning direction so as to reciprocate the working plane 21a of the object table 21 in the sub scanning direction relative to the inkjet heads 24. In this manner, the object table driver 27 allows the working plane 21a to reciprocate in the sub scanning direction relative to the inkjet heads 24 and the ultraviolet irradiator 25. The sub scanning direction moving portion 27b allows for relative reciprocatory movements of the working plane 21a and of the inkjet heads 24 and the ultraviolet irradiator 25 in the sub scanning direction. In this embodiment, the sub scanning direction moving portion 27b moves the object table 21 in the sub scanning direction, which is, however, not limited. The sub scanning direction moving portion 27b may move the inkjet heads 24 and the ultraviolet irradiator 25 together with the Y bar 22 in the sub scanning direction.

The controller 28 controls the operations of the inkjet heads 24, flattening roller R, ultraviolet irradiator 25, carriage driver 26, and object table driver 27 in the object shaping apparatus 20. The controller 28 includes a computing device, a hardware device such as memory, and programs to execute predetermined functions required of these devices. The controller 28 controls a respective one of the inkjet heads 24 and thereby regulates the amount, timing, and duration of ejection of the ultraviolet-curable ink. The controller 28 controls the ultraviolet irradiator 25 and thereby regulates the intensity of ultraviolet light radiated, timing of exposure, and duration of exposure. The controller 28 controls the carriage driver 26 and thereby regulates relative movement of the carriage 23 in the main scanning direction. The controller 28 controls the object table driver 27 and thereby regulates relative movements of the object table 21 in the vertical direction and in the sub scanning direction.

The input portion 29 is coupled to the controller 18 and used to input the object-shaping data for the three-dimensional object 1 and to set conditions for shaping the three-dimensional object 1. The input portion 29 may include a PC coupled to the controller 28 wirelessly or by wire and various devices including terminals.

The display portion 30 is coupled to the controller 28 so as to display information associated with the operation to shape the three-dimensional object 1. The display portion 30 may include such devices as a display screen. The display portion 30 may include a touch panel integral with the input portion 29.

Hereinafter is described an operation control associated with the method for shaping the three-dimensional object 1 carried out by the object shaping apparatus 20 (hereinafter, shaping control). Based on the object-shaping data for the three-dimensional object 1, the controller 28 of the object shaping apparatus 20 executes the shaping control associated with the operation to shape the three-dimensional object 1. The object-shaping data includes shape-related data for the three-dimensional object 1 (for example, polygon data), and color data representing coloration of the colored region 14 in the three-dimensional object 1 (for example, RGB color or CMYK color data).

The controller 28 generates slice data based on the object-shaping data which is set on an operation setting region 40 corresponding to the working plane 21a of the object table 21. The slice data, an example of which is illustrated in FIG. 4, is used to form a layered structure (slice layers 17) constituting the three-dimensional object 1. The slice data contains data of the components 11a, 12a, 13a, 14a, 14b, and 15a in the regions 11, 12, 13, 14, and 15. The controller 28 executes the shaping control to prompt the respective structural elements to form the slice layers 17 based on the slice data and to stack the slice layers 17 on one another so as to shape the three-dimensional object 1 including the colored region 14.

When the three-dimensional object 1 is shaped under the shaping control, the color components 14a are formed with the color inks and the supplementary components 14b are formed with the supplementary ink to form the colored region 14 (color region forming step). In the color region forming step, the white color ink is used as the supplementary ink to form the white color supplementary components W, and the transparent ink is used as the supplementary ink to form the transparent supplementary components T. In the color region forming step, the colored region is formed, so that a greater number of white color supplementary components W than the transparent supplementary components T are formed on the inner side of the three-dimensional object 1, and a greater number of transparent supplementary components T than the white color supplementary components W are formed on the outer layer side of the three-dimensional object 1.

According to this embodiment, an ink density in the colored region may be adjusted by combined use of the white color ink and the transparent ink. Therefore, the white color ink may reflect incident light entering the colored region 14, while the transparent ink may transmit therethrough the incident light. When the light-reflective region 12 is formed on the inner side than the colored region 14, the incident light is reflected in the colored region 14 and is reflected in the light-reflective region 12 as well. As a result, vivid coloration of the colored region 14 may be feasible.

There are two effects with the white color supplementary component W (white ink W); light reflecting effect, and light blocking effect. Therefore, when light is entering the colored region 14, the possibility of the light being blocked by the transparent supplementary components T (transparent ink) may be reduced by increasing the proportion of the transparent supplementary components T formed on the outer layer side of the three-dimensional object 1. When light is being transmitted through the color components 14a of the colored region 14, the possibility of the light being blocked by the white color supplementary components W may be reduced by increasing the proportion of the white color supplementary components W formed on the inner side of the three-dimensional object.

The white color ink and the transparent ink used at a half-and-half ratio in the colored region 14 may allow the white color supplementary components W and the transparent supplementary components T to be allocated at an equal ratio. This may facilitate allocation of these two different supplementary components when the object-shaping data is generated to produce the three-dimensional object 1, alleviating any loads associated with computations necessary for generating the object-shaping data.

According to this embodiment, the light-reflective region 12 may allow light transmitted through the colored region 14 to be reflected well. This may improve coloration of the colored region 14. The dividing region 13 may avoid any physical interference between the colored region 14 and the light-reflective region 12. As a result, the transmission of incident light through the colored region 14 and the reflection of incident light by the light-reflective region 12 may be both successfully facilitated and improved.

In this embodiment providing the protective region 15, the colored region 14 may be protected by the protective region 15. The transparent ink used in the transparent supplementary components T may be conveniently used to form the protective region 15 and the dividing region 13 as well. This may avoid any unnecessary increase of the number and types of inks to be used.

What is claimed is:

1. A three-dimensional object shaped by a layer lamination technique, and the three-dimensional object comprising:
a colored region, having a certain thickness in a surface normal direction,
wherein the colored region comprising a white color ink and a transparent ink used to compensate for insufficiency of an ink density in a portion of the colored region in which a color ink alone fails to fulfill a predetermined ink density.

2. The three-dimensional object according to claim 1, wherein
a higher proportion of the white color ink than the transparent ink is used on an inner side, and
a higher proportion of the transparent ink than the white color ink is used on an outer layer side.

3. The three-dimensional object according to claim 1, wherein
the white color ink and the transparent ink are used at a half-and-half ratio.

4. The three-dimensional object according to claim 2, wherein
the white color ink and the transparent ink are used at a half-and-half ratio.

5. The three-dimensional object according to claim 1, further comprising:
a light-reflective region, being disposed on the inner side than the colored region.

6. The three-dimensional object according to claim 2, further comprising:
a light-reflective region, being disposed on the inner side than the colored region.

7. The three-dimensional object according to claim 3, further comprising:
a light-reflective region, being disposed on the inner side than the colored region.

8. The three-dimensional object according to claim 5, further comprising:
a dividing region, being disposed between the colored region and the light-reflective region.

9. The three-dimensional object according to claim 6, further comprising:
a dividing region, being disposed between the colored region and the light-reflective region.

10. The three-dimensional object according to claim 7, further comprising:
a dividing region, being disposed between the colored region and the light-reflective region.

11. The three-dimensional object according to claim 8, further comprising:
a protective region, being disposed on the outer layer side than the colored region,
wherein at least one of the protective region and the dividing region is formed with the transparent ink.

12. The three-dimensional object according to claim 9, further comprising:
a protective region, being disposed on the outer layer side than the colored region,
wherein at least one of the protective region and the dividing region is formed with the transparent ink.

13. The three-dimensional object according to claim 10, further comprising:
a protective region, being disposed on the outer layer side than the colored region,
wherein at least one of the protective region and the dividing region is formed with the transparent ink.

14. A method for shaping a three-dimensional object by a layer lamination technique, the three-dimensional object comprising a colored region having a certain thickness in a surface normal direction, and the method for shaping the three-dimensional object comprising:
utilizing a white color ink and a transparent ink to compensate for insufficiency of an ink density in a portion of the colored region in which a color ink alone fails to fulfill a predetermined ink density.

15. The method for shaping the three-dimensional object according to claim 14, wherein
the color region is formed, so that a higher proportion of the white color ink than the transparent ink is used on an inner side of the three-dimensional object, and a higher proportion of the transparent ink than the white color ink is used on an outer layer side of the three-dimensional object.
